(19) United States
(12) Patent Application Publication
(10) Pub. No.: US 2023/0305489 A1
(43) Pub. Date: Sep. 28, 2023

(54) SYSTEMS AND METHODS FOR COMPUTER-GENERATED HOLOGRAM IMAGE AND VIDEO COMPRESSION

(71) Applicant: Meta Platforms Technologies, LLC, Menlo Park, CA (US)

(72) Inventors: Changwon JANG, Seattle, WA (US); Richard WEBB, Sammamish, WA (US); Liang SHI, Cambridge, MA (US); Lei XIAO, Redmond, WA (US); Changil KIM, Seattle, WA (US); Douglas Robert LANMAN, Bellevue, WA (US)

(73) Assignee: Meta Platforms Technologies, LLC, Menlo Park, CA (US)

(21) Appl. No.: 17/702,379

(22) Filed: Mar. 23, 2022

(51) Int. Cl. G03H 1/02; G03H 1/04; H04N 19/91; H04N 19/124; G06T 19/00

(52) U.S. Cl. CPC G03H 1/024; G03H 1/04; H04N 19/91; H04N 19/124; G06T 19/006; G03H 2001/0088

(57) ABSTRACT

According to examples, a learning based, end-to-end compression system may include an encoder, which may receive a complex hologram image and encode a latent code for a real component and an imaginary component of the hologram image. The system may also include a quantizer to quantize the latent code and a transform block, which may entropy-code the quantized latent code to obtain a compressed image. The system may further include a generator to decode the compressed image and a discriminator, which may classify the decoded image to obtain an uncompressed image. In case of holographic video input, the encoder may encode a frame to obtain a standard compressed frame and a residual to a latent code. The generator may decode the standard compressed frame and the latent code to obtain a reconstructed residual, and the discriminator may combine the uncompressed standard frame and the reconstructed residual.

### TECHNICAL FIELD

This patent application relates generally to hologram image and video compression, and more specifically, to artificial intelligence (AI) based end-to-end compression systems, where an artificial intelligence (AI) encoder network may compress a hologram into a low-dimensional latent code and a decoder network may reconstruct the hologram.

### BACKGROUND

Near-eye displays have become increasingly popular for a number of applications. Among a number of techniques to generate content for near-eye displays, computer-generated holography (CGH) may present the potential to create life-like 3D imagery. Holograms, for example, may be computer-generated by modelling two wavefronts (a wavefront of interest and a second, reference wavefront) and adding them together digitally.

Holographic near-eye displays may be capable of delivering high-quality 3D imagery with focus cues. However, content resolution requirements to simultaneously support a wide field of view (FOV) and a sufficiently large eye box may be substantially large. Furthermore, consequent data storage and streaming overhead may impose considerable challenges for practical virtual reality (VR) and/or augmented reality (AR) applications.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display where artificial intelligence (AI) based end-to-end compression may be implemented, according to an example.

FIG. 2 illustrates video exchange with artificial intelligence (AI) based end-to-end compression between a content server, a computing device, and a head-mounted display (HMD) device, according to an example.

FIG. 3 illustrates a block diagram of an encoder for video compression, according to an example.

FIG. 4 illustrates a block diagram of a decoder for video decompression, according to an example.

FIG. 5 illustrates a diagram of an artificial intelligence (AI) based end-to-end hologram compression system, according to an example.

FIG. 6A illustrates a flowchart of a method to employ artificial intelligence (AI) based end-to-end hologram image compression, according to an example.

FIG. 6B illustrates a flowchart of a method to employ artificial intelligence (AI) based end-to-end hologram video compression, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

As discussed herein, holographic near-eye displays may deliver high-quality 3D imagery such as computer-generated holography (CGH) with one or more focus cues. Content resolution requirements to simultaneously support a wide field of view and a sufficiently large eye box in a near-eye display may be very large. Thus, resulting data storage and streaming overheads may impose a substantial challenge for practical applications. Computer-generated holography (CGH) represents a 2D slice of optical wavefront as a complex-valued image, that is, an optical field at the hologram plane is defined as a set of real and imaginary complex values, which differs from conventional image and video domains. Holograms may have a unique property that is not supported by other display technologies. Holograms may allow a viewer to focus on objects at different depths without requiring any change in the displayed image. The viewer's eye may combine the real and imaginary components differently depending on the eye's focal distance. Objects at the focal depth of the eye may be in focus and objects at different depths may be appropriately blurred (defocused).

Computer-generated holography (CGH) may also necessitate high-frequency interference fringes to produce realistic depth of field effects, whereas conventional image and video codecs typically discard visually insignificant high-frequency details to achieve higher compression rate. These unmatched design choices may result in suboptimal compression performance when existing codecs are applied to computer-generated holography (CGH). For practical virtual reality (VR) and augmented reality (AR) applications, ultra-high resolution CGH (16K+) may be needed to simultaneously support a wide field of view and a large eye box, which may further amplify codec inefficiency and degrade image quality or require impractical data storage and/or bandwidth capacity.

Disclosed herein are systems and apparatuses that may provide deep-learning based methods and/or techniques for efficient compression of complex-valued hologram image and video. A learning based end-to-end compression technique for smooth-phase complex hologram images may include an encoder network learning to compress the hologram into a low-dimensional latent code and a decoder network reconstructing the hologram. Latent code may represent compressed data, where similar data points are closer together in space. In some examples, the encoder network may be trained as a conditional generative adversarial network (GAN). A generator model in a GAN architecture may take a point from latent space (code) as input and generate a new image. For hologram videos, an encoder (e.g., according to High Efficiency Video Coding “HEVC” standard, also known as H.265 or similar) in a high quality setting may compress the low and mid-frequency content, while an encoder-decoder network may compress the high-frequency residual, which is critical for 3D image formation, with the assistance of motion vectors in the HEVC video.

In some examples, a 6-channel tensor input created by concatenating real and imaginary parts of the complex hologram may be utilized. The encoder may produce a quantized latent code, which may be further decoded by a generator to obtain a lossy reconstruction. Using a probability model and an entropy coding algorithm (e.g., arithmetic coding), which is a lossless data compression scheme, the latent may be stored losslessly using a logarithmic bit rate. Lossless reconstruction may recreate an original image with a cost of greater bandwidth, storage, etc. Lossy reconstruction results in reduced bandwidth, etc. by losing some features in the image. In some examples, probability models may be used to train an artificial intelligence (AI) encoder-decoder network, where an encoder-generator and a discriminator may provide rivaling suggestions as to whether the lossy reconstruction is real or fake and the system may select a better option for improved compression.

For hologram video compression, amplitude and phase of the complex hologram may be compressed into two regular videos using, for example, H.265 with a suitable constant rate factor, a quality of which may be insufficient to preserve the interference fringes necessary for recovering the 3D scene details. P-frames and B-frames in each video may encode the motion vectors, which may be leveraged during the residual learning to compensate for any loss of interference fringes. The network may be trained to predict the residual with a 12-channel tensor input created by concatenating the residual and the H.265 compressed frame along the channel dimension. Example hologram image or video compression techniques may achieve superior image quality over conventional image and video codecs on compressing smooth-phase complex holograms for diverse scenes. Through the substantial reduction of data to be stored and/or streamed for computer-generated holography (CGH), such imagery may be made available to smaller devices such as head-mount displays and similar via nominal bandwidth systems. Other benefits and advantages may also be apparent.

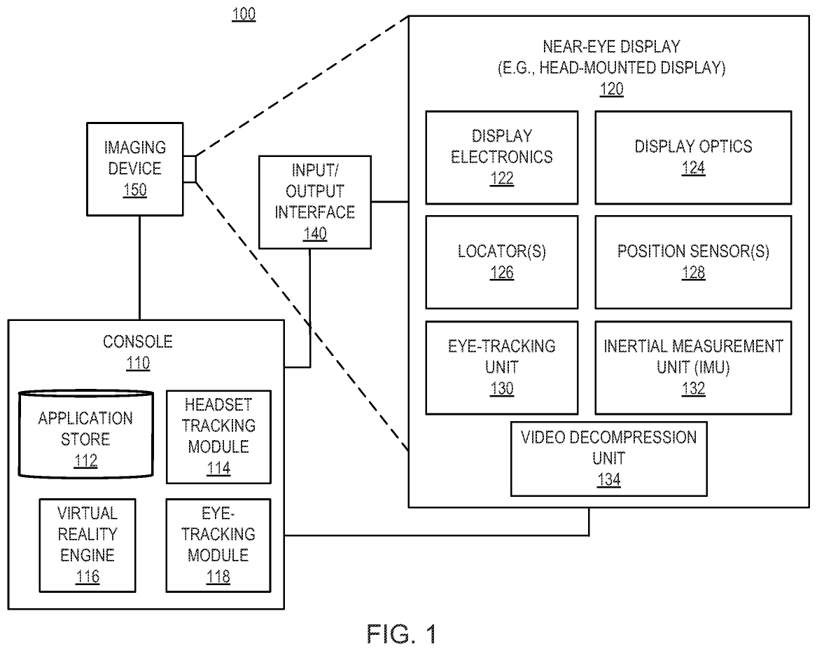

FIG. 1 illustrates a block diagram of an artificial reality system environment 100 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements, and may include use of technologies associated with virtual reality (VR), augmented reality (AR), and/or mixed reality (MR). As used herein a “user” may refer to a user or wearer of a “near-eye display.”

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user.

In some instances, for a near-eye display system, it may generally be desirable to expand an eyebox, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular HMD) or both eyes (for binocular HMDs). Also, as used herein, an “eyebox” may be a two-dimensional box that may be positioned in front of the user's eye from which a displayed image from an image source may be viewed.

In some examples, the near-eye display 120 may be implemented in any suitable form-factor, including a HMD, a pair of glasses, or other similar wearable eyewear or device. Additionally, in some examples, the functionality described herein may be used in a HMD or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye-tracking unit 130. In some examples, the near eye display 120 may also include one or more locators 126, one or more position sensors 128, and an inertial measurement unit (IMU) 132. In some examples, the near-eye display 120 may omit any of the eye-tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube reflector, a reflective marker, a type of light source that contrasts with an environment in which the near-eye display 120 operates, or any combination thereof.

In some examples, the near-eye display 120 may also include a video decompression unit 134. The video decompression unit 134 may be part of a compression/decompression network to provide efficient compression of complex-valued hologram image and video. An encoder network (e.g., at the console 110 or a server communicatively coupled to the console 110) may learn to compress the hologram into a low-dimensional latent code, and the video decompression unit 134 may include a decoder network to reconstruct the hologram. Alternatively, the decoder network may be included in the console 110 and deconstruction performed at the console 110.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from one or more of external imaging device 150, the near-eye display 120, and the input/output interface 140. For example, in the example shown in FIG. 1, the console 110 may include an application store 112, a headset tracking module 114, a virtual reality engine 116, and an eye-tracking module 118. Some examples of the optional console 110 may include different or additional modules than those described in conjunction with FIG. 1. Functions further described below may be distributed among components of the console 110 in a different manner than is described here.

In some examples, the console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the console 110 described in conjunction with FIG. 1 may be encoded as instructions in the non-transitory computer-readable storage medium that, when executed by the processor, cause the processor to perform the functions further described below. It should be appreciated that the console 110 may or may not be needed or the console 110 may be integrated with or separate from the near-eye display 120.

In some examples, the application store 112 may store one or more applications for execution by the console 110. An application may include a group of instructions that, when executed by a processor, generates content for presentation to the user. Examples of the applications may include gaming applications, conferencing applications, video playback application, or other suitable applications.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

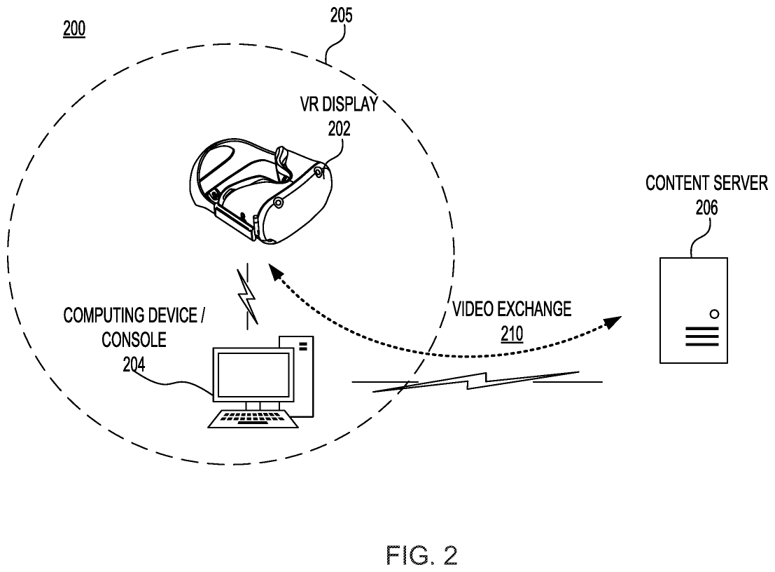

FIG. 2 illustrates video exchange with artificial intelligence (AI) based end-to-end compression between a content server, a computing device, and a head-mounted display (HMD) device, according to an example. Diagram 200 shows a content server 206 providing (and optionally receiving) via video exchange 210 content that may include video, still images, and holograms (in video or image formats) to (and from) a computing device/console 204. The computing device/console 204 may be communicatively coupled to a head-mounted display (HMD) device 202 and provide received content to the head-mounted display (HMD) device 202 for presentation to a user.

In some examples, the head-mounted display (HMD) device 202 may be a part of a virtual reality (VR) system, an augmented reality (AR) system, a mixed reality (MR) system, another system that uses displays or wearables, or any combination thereof. In some examples, the virtual reality (VR) system, the augmented reality (AR) system, or the mixed reality (MR) system may also use other types of displays such as a projector, a wall display, etc.

In some examples, the head-mounted display (HMD) device 202 may present to a user, media or other digital content including virtual and/or augmented views of a physical, real-world environment with computer-generated elements. Examples of the media or digital content presented by the HMD device 200 may include images (e.g., two-dimensional (2D) or three-dimensional (3D) images), holograms, videos (e.g., 2D or 3D videos), audio, or any combination thereof. In some examples, the images, holograms, and videos may be presented to each eye of a user by one or more display assemblies (not shown in FIG. 2) enclosed in the body of the head-mounted display (HMD) device 202. In other examples, some or all of the electronics performing image and/or video processing and storing functionalities in the computing device/console 204 may be incorporated into the head-mounted display (HMD) device 202) as shown by the dashed line 205 in diagram 200.

As holographic images and videos may require large amounts of data to be stored or exchanged for enhanced user experience, learning based end-to-end compression techniques for smooth-phase complex hologram images may be used for the video exchange 210 (and/or any exchange between the computing device/console 204 and the head-mounted display (HMD) device 202). In some examples, such techniques may include an encoder network learning to compress the hologram into a low-dimensional latent code and a decoder network reconstructing the hologram. For hologram videos, an encoder in a high quality setting may compress the low and mid-frequency content, while an encoder-decoder network may compress the high-frequency residual with the assistance of motion vectors in HEVC video.

In some examples, a 6-channel tensor input created by concatenating the real and imaginary parts of the complex hologram may be utilized. For hologram video compression, amplitude and phase of the complex hologram may be compressed into two regular videos using, for example, H.265 with a suitable quality setting.

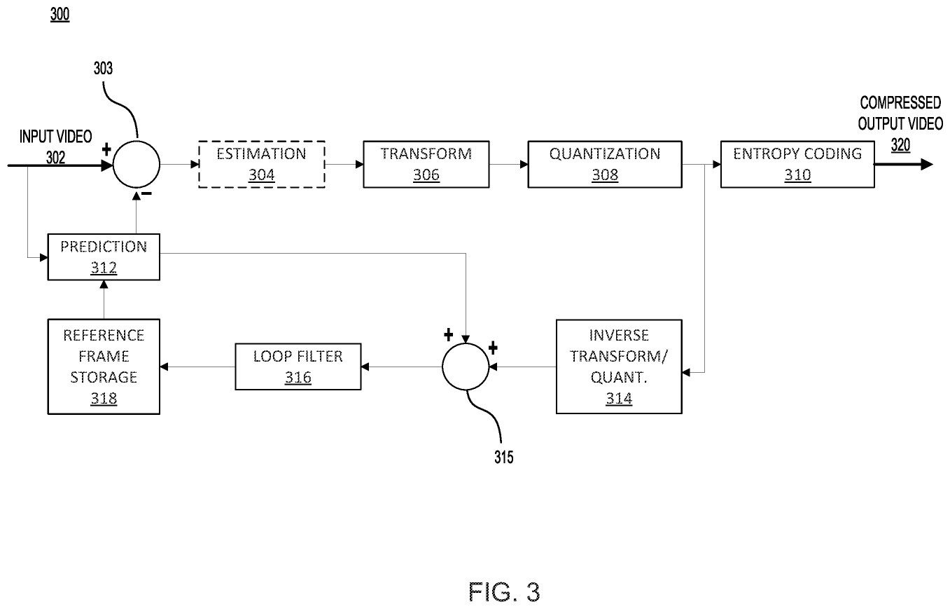

FIG. 3 illustrates a block diagram of an encoder for video compression, according to an example. The functional block diagram 300 includes uncompressed input video 302 being provided through a subtraction block 303 to an optional estimation block 304. An output of the optional estimation block 304 may be provided to a transform block 306 and then to a quantization block 308. An output of the quantization block 308 may be provided to an entropy coding block 310, whose output is a compressed output video 320. The compression (also referred to as encoding system) may also include a loop, where an output of the quantization block 308 may be provided to an inverse transform and quantization block 314. An output of the inverse transform and quantization block 314 may be provided through an addition block 315 to a loop filter 316, whose output is also provided to reference frame storage block 318. The prediction block 312 may receive as input data from the reference frame storage block 318 and the uncompressed input video 302. An output of the prediction block 312 may be subtracted from the input video 302 at the subtraction block 303, before the input video 302 is provided to the estimation block 304. The output of the prediction block 312 may also be added to the output of the inverse transform and quantization block 314 at the addition block 315 prior to the loop filter 316.

While example artificial intelligence (AI) based end-to-end hologram compression systems are described in conjunction with High Efficiency Video Coding “HEVC” standard, also known as H.265, implementations are not limited to the H.265 standard. A hologram compression system may be implemented using other video compression/decompression standards such as H.264 or other standard or proprietary systems using the principles described herein.

In some examples, the optional estimation block 304 may be used to identify and eliminate temporal redundancies that may exist between individual images. When searching for motion relative to a previous image, the image to be encoded is called a P-image (or P-frame). When searching both within a previous image and a future image, the image to be encoded is called a B-image (or B-frame). In scenarios, where motion estimation cannot be exploited, intra-estimation may be used to eliminate spatial redundancies. Intra-estimation may attempt to predict a current block by extrapolating neighboring pixels from adjacent blocks in a defined set of different directions. The difference between the predicted block and the actual block may then be coded. The estimation block 304 is an optional component in implementation of H.265 systems and may be replaced with the prediction block 312 in some examples.

In some examples, results from the estimation block 304 (or combination of input video and prediction) may be transformed from a spatial domain into a frequency domain. Example transformations may include, but are not limited to, a DCT-like 8×8 transform, a 4×4 integer transform, 2×2 or 4×4 secondary Hadamard transform, etc. The coefficients from the transform block 306 may be quantized at quantization block 308. Quantization is a lossy compression technique achieved by compressing a range of values to a single quantum value. When the number of discrete symbols in image or video data is reduced, the image or video may become more compressible. For example, reducing the number of colors required to represent a digital image may allow reduction of file size. Quantization may reduce an overall precision of the integer coefficients and eliminate high frequency coefficients, while maintaining perceptual quality. The quantization block 308 may also be used for constant bit rate applications to control the output bit rate.

In some examples, the entropy coding block 310 may map symbols representing motion vectors, quantized coefficients, and macroblock headers into actual bits. Entropy coding may improve coding efficiency by assigning a smaller number of bits to frequently used symbols and a greater number of bits to less frequently used symbols. Before entropy coding can take place, the quantized coefficients may be serialized. Depending on whether these coefficients were originally motion estimated or intra estimated, a different scan pattern may be selected to create the serialized stream. The scan pattern may order the coefficients from low frequency to high frequency. Then, run-length encoding may be used to group trailing zeros because higher frequency quantized coefficients tend to be zero, resulting in more efficient entropy coding.

In some examples, the loop filter 316 may be a de-blocking filter. The loop filter 316 may operate on both 16×16 macroblocks and 4×4 block boundaries. In the case of macroblocks, the filter may remove artifacts that may result from adjacent macroblocks having different estimation (or prediction) types and/or different quantizer scales. In the case of blocks, the filter may remove artifacts that may be caused by transform/quantization and from motion vector differences between adjacent blocks. The loop filter 316 may modify the two pixels on either side of the macroblock/block boundary using a content adaptive non-linear filter.

Prediction block 312 may be used in place of the optional estimation block 304, in some examples, and may provide temporal redundancy removal. In intra-prediction, an image is coded without reference to other images. In inter-image prediction, the image may be coded based on uni-directional prediction (from one prior coded image) or bi-directional prediction (from two prior coded images). Inter-prediction is equivalent to motion estimation using motion vectors.

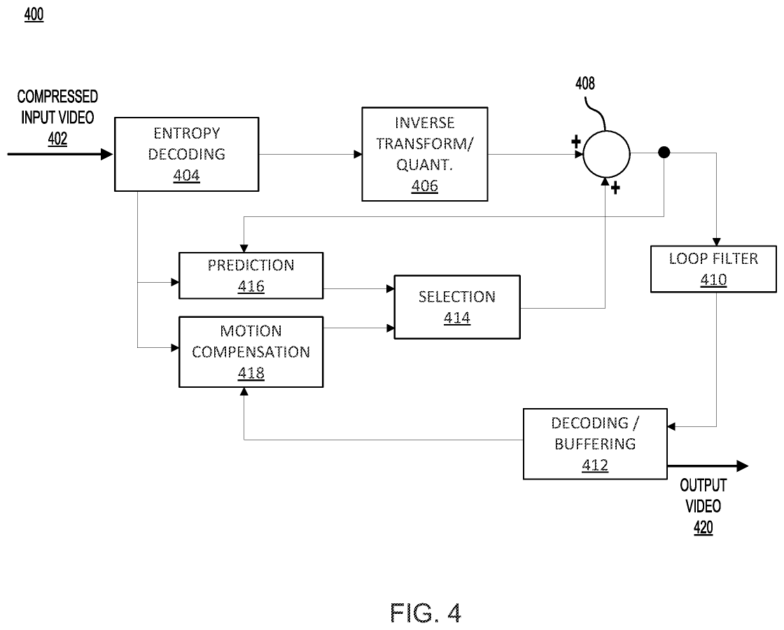

FIG. 4 illustrates a block diagram of a decoder for video decompression, according to an example. Functional block diagram 400 includes compressed input video 402 being provided to entropy decoding block 404, an output of which may be provided to an inverse transform and inverse quantization block 406. The decoded input video may also be provided to prediction block 416 and motion compensation block 418, outputs of which may be provided to a selection block 414. An output of the selection block 414 and the inverse transform and inverse quantization block 406 may be combined at addition block 408, an output of which may be provided to a loop filter 410 (as well as the prediction block 416). An output of the loop filter 410 may be provided to a decoding/buffering block 412, which may provide as output the uncompressed output video 420. An output of the decoding/buffering block 412 may also be provided to the motion compensation block 418.

In some examples, the entropy decoding block 404 may extract quantized coefficients and motion vectors from the bit stream and provide the quantized coefficients to the inverse transform and inverse quantization block 406 for inverse transformation and inverse quantization. The entropy decoding block 404 may also provide motion vector information to the motion compensation block. The selection block 414 may selectively provide an output of the prediction block 416 or an output of the motion compensation block 418 to be combined with the inverse quantized image data at the addition block 408. The combined data may be provided as input to the prediction block 414 along with the coefficients from the entropy decoding block 404. The loop filter 410 may be a de-blocking filter providing filtered results to the decoding/buffering block 412. The decoding/buffering block 412 may include line buffers for the entropy decoding block 404 and line buffers for the prediction block 412 and the loop filter 410.

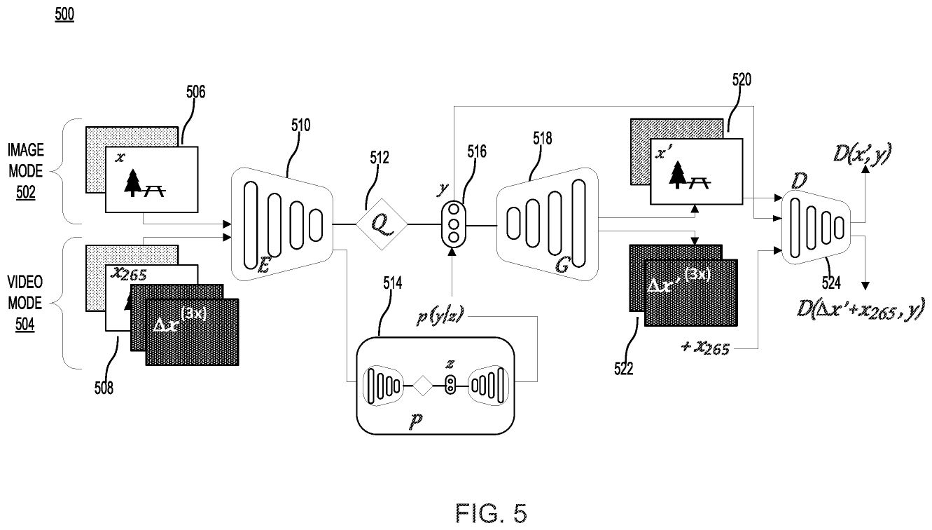

FIG. 5 illustrates a diagram of an artificial intelligence (AI) based end-to-end hologram compression system, according to an example. Diagram 500 shows a tensor input 506 created by concatenating real and imaginary parts of the complex hologram being provided to an encoder 510 in an image mode 502. The encoder 510 together with a quantizer and transform block 512, 516 may produce a quantized latent, which may be further decoded by a generator 518 to obtain a lossy reconstruction. A discriminator 524 may produce a scalar value indicating the probabilities that the inputs are real or fake (synthetic) using a probability model 514. A similar process may be performed in a video mode 504 by providing a double tensor input 508 that includes compressed amplitude and phase into two regular videos.

In some examples, the encoder 510 (E) may encode one latent code for both real and imaginary component of the hologram. A 6-channel tensor input created by concatenating the real and imaginary parts of the complex hologram may be utilized. The latent code may be quantized by Q at quantizer 512, entropy coded with side information at transform block 516 generated through probability model 514 (P). The latent code may then be decoded by generator 518 (G) and classified by discriminator 524 (D). For video compression, the encoder 510 (E) may take an H.265 compressed frame 508 with its associated residual and encode a latent code only for reconstructing the residual. The reconstructed residual may be added back to the H.265 frame (522) to improve the holographic video quality. While H.265 standard is used herein as an illustrative example, the principles described herein may be applied to other video standards as well.

In some examples, the 6-channel tensor input, in image mode 502, may be designated as xϵ|R^{6×W}ₓ^{xH}_{y}, where Wₓ and H_{y} are spatial resolution of the hologram (real and imaginary parts). The quantized latent produced by the encoder 510 (E) may be designated as y=E(x), which may be further decoded by the generator 518 (G) to obtain a lossy reconstruction xt=G(y). Using the probability model 514 (P) and an entropy coding algorithm (e.g., arithmetic coding), the latent y may be stored losslessly using a logarithmic bit rate r(y)=log(P(y)). The discriminator 524 (D) may produce a scalar value D(y,x) and D(y,xt) indicating the probabilities that x and xt are real or fake (synthetic), respectively.

In some examples, the system may be trained as a conditional generative adversarial network (GAN), where the (E, G) and the D compete as two rivaling parties: (E, G) tries to “fool” D into believing its lossy reconstructions are real, while D aims to classify the lossy reconstructions as fake and the uncompressed inputs as true. A loss function for training (E, G), for example, may be represented by the following expression/equation:

[symbol]

_{(E,G)}=wᵣr(y)+wₕₒₗₒ∥x−x′∥₁+w_{fs}d_{fs}(x,x′) −w_{D} log(D(x′,y)). (1)

where wᵣ, wₕₒₗₒ, w_{fs}, and W_{D} may represent hyper-parameters controlling a trade-off between terms with d_{fs} defining a dynamic focal stack loss that encourages a focal stack reconstructed from the compressed input to match the one from the uncompressed input.

In some examples, a loss function for training, D, may be represented by the following expression/equation:

[symbol]

_{D}=−log(1−D(x′,y))−log(D(x,y)), (2)

which may encourage the uncompressed input to be classified as 1 and the compressed input as 0.

For hologram video compression, compressing each frame to an individual latent may prevent exploitation of temporary redundancy. In some examples, amplitude and phase of the hologram may be compressed into two regular videos using H.265, a quality of which may be insufficient to preserve the interference fringes necessary for recovering the 3D scene details. Nevertheless, P-frames and B-frames in each video may encode motion vectors, which may be leveraged during the residual learning. Denoting a H.265 compressed frame (converted to real+imaginary representation) x₂₆₅ and a residual Δx=x−x₂₆₅, the network may be trained to predict Δx with a 12-channel tensor input created by concatenating Δx and x₂₆₅ along the channel dimension. Δxt being designated as the compressed residual and Δy being the latent of Δx, the network may be trained, for example, using an updated loss for (E, G), which may be represented by the following expression/equation:

[symbol]

_{Δ(E,G)}=w_{Δr}r(Δy)+w_{Δholo}∥Δx−Δx′∥₁ −w_{ΔD} log(D(Δx′+x₂₆₅,Δy)) +w_{Δfs}d_{Δfs}(Δx+x₂₆₅,Δx′+x₂₆₅) (3)

and an updated loss for D may be represented by the following expression/equation:

[symbol]

_{D}=−log(1−D(Δx′+x₂₆₅,Δy))−log(D(Δx+x₂₆₅,Δy)). (4)

In some examples, one group of pictures (GOP) may be considered as a batch of frames when encoding the residual frames. The residual of I-frame in the GOP may be first compressed and denoted as Δx_{I}′. Defining x_{P} as the anchored P-frame and x_{265_P} as the H.265 compressed frame, a motion-compensated P-frame residual may, for example, be represented by the following expression/equation:

Δx_{P}=x_{P}−(x_{265_P}+warp(Δx′_{I},M_{I→P})), (5)

where M_{I→P} may represent a motion vector from the I-frame to the P-frame. Defining Δx_{P}′. as the compressed residual and Δx_{P}=Δx_{P}′+warp(Δx_{I}′, M_{I→P}), the motion-compensated residual of an anchored B-frame may, for example, be represented by the following expression/equation:

Δx_{B}=x_{B}−(x_{265_B}+warp(Δx′_{I},M_{I→B})+warp(Δ̅x̅_̅{̅P̅}̅,M_{P→B})), (6)

where M_{I→B}, M_{P→B} may represent the motion vector from the I-frame to the B-frame and from the P-frame to the B-frame, respectively.

To achieve system compactness, holographic displays may offset a 3D image from the hologram plane to reduce an air gap between eyepiece and the spatial light modulator. Thus, an example system may be trained, for example, for 5 mm, 10 mm, and 15 mm offsets to evaluate its robustness. In some examples, a hyper-prior model may be used for the probability mode, and the encoder 510 and discriminator 516 may be pre-trained for 1 million iterations using the loss function L(E, G) for the encoder 510 and discriminator 516.

For hologram images, the example system may faithfully preserve mid- and high-frequency fringe details amid a smeared subject content due to defocusing. In some scenarios with heavily intermingled features due to interlaced foreground and background subjects, an interaction between randomly-oriented objects may push the aggregated fringes away from contouring shapes. An example system may handle such interactions through the focal stack loss and retain the dominating features for producing a sharp foreground after refocusing.

In an example scenario for hologram videos with an object in fast motion and non-rigid deformation (relatively stationary background), an example system may reduce bit-per-pixel (bpp) rate for P/B-frames by 27%/39% with motion compensation preserving feature sharpness of the object. In another example scenario, where the camera may undergo a revolving motion and all pixels translate with a scale inverse proportional to distance to the camera, the example system may still provide a 6%/14% bpp reduction (for P/B-frames) through the use of motion compensation.

Thus, an example artificial intelligence (AI) based end-to-end hologram compression system may achieve superior image quality over conventional image and video codecs in compressing smooth-phase complex holograms for diverse scenes.

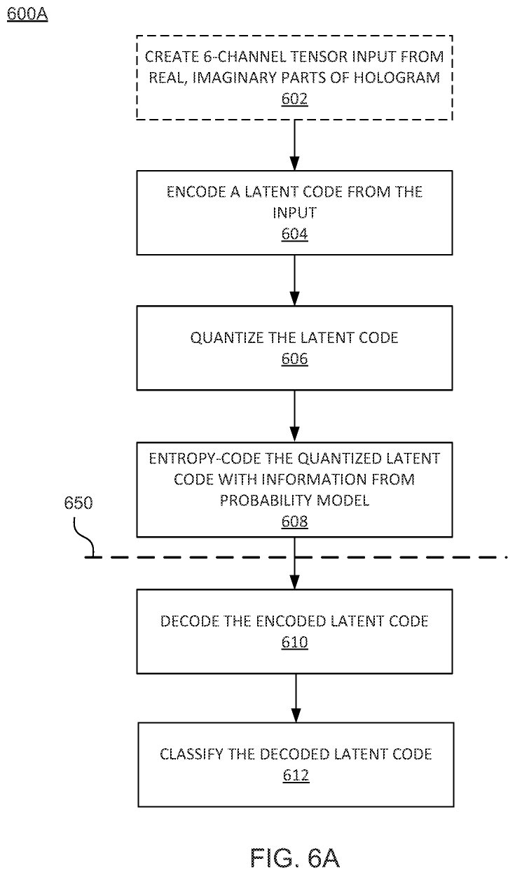

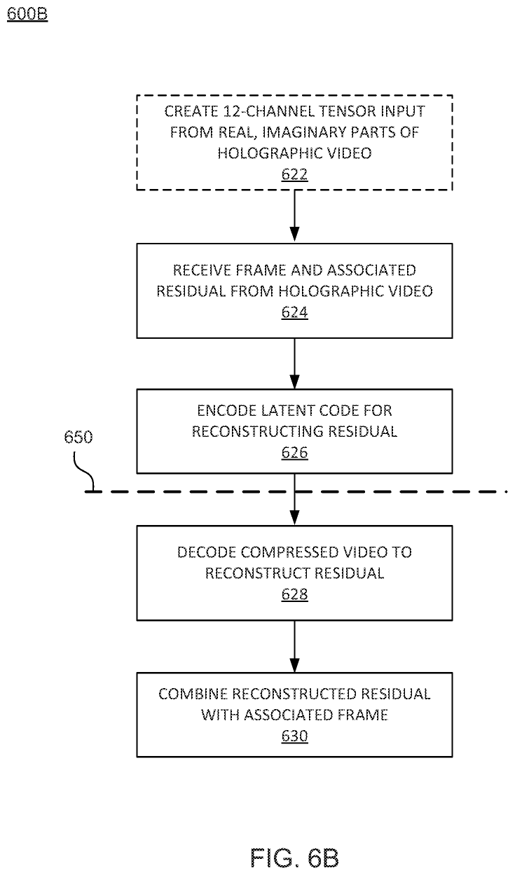

FIG. 6A illustrates a flowchart of a method to employ artificial intelligence (AI) based end-to-end hologram image compression, according to an example. Each block shown in FIG. 6A may further represent one or more processes, methods, or subroutines, and one or more of the blocks may include machine-readable instructions stored on a non-transitory computer readable medium and executed by a processor or other type of processing circuit to perform one or more operations described herein.

At optional block 602, an artificial intelligence (AI) based end-to-end hologram compression system such as the one shown in diagram 500 of FIG. may create a 6-channel tensor input from real and imaginary parts of a complex hologram. Block 602 is optional because, in some examples, the 6-channel tensor input may be created from real and imaginary parts of a complex hologram at a circuit, device, or system outside the compression system and provided as input to the compression system. At 604, the encoder 510 may encode a latent code from the input. At 606, the quantizer 512 may quantize the encoded latent code. At 608, the transform block 516 may entropy-code the quantized latent code with information from the probability model 514.

Following transmission 650 of the compressed image, the generator 518 may decode the encoded latent code at 610. At 612, the discriminator 622 may classify the decoded latent code to obtain the uncompressed image.

FIG. 6B illustrates a flowchart of a method to employ artificial intelligence (AI) based end-to-end hologram video compression, according to an example. Each block shown in FIG. 6B may further represent one or more processes, methods, or subroutines, and one or more of the blocks may include machine-readable instructions stored on a non-transitory computer readable medium and executed by a processor or other type of processing circuit to perform one or more operations described herein.

At optional block 622, an artificial intelligence (AI) based end-to-end hologram compression system such as the one shown in diagram 500 of FIG. may create a 12-channel tensor input from real and imaginary parts of a complex hologram. Block 622 is optional because, in some examples, the 12-channel tensor input may be created from real and imaginary parts of a complex hologram at a circuit, device, or system outside the compression system and provided as input to the compression system. At 624, the encoder 510 may receive a frame and associated residual from the holographic video. At 626, the encoder 510 may encode a latent code only for the residual.

Following transmission 650 of the compressed video, the generator 518 may decode the encoded latent code to reconstruct the residual at 626. At 630, the discriminator 622 may combine the reconstructed residual with the associated frame to obtain the uncompressed holographic video.

According to some examples, a system for image or video compression may include a processor and a memory storing instructions. When executed by the processor, the instructions may cause the processor to receive a complex hologram image; encode a latent code for a real component and an imaginary component of the complex hologram image; quantize the latent code; and compress the quantized latent code using an entropy coding technique to obtain a compressed image.

According to some examples, the complex hologram image may be received as a 6-channel tensor input. The quantized latent code may be compressed using a probability model. The entropy coding technique may employ arithmetic coding such that the compressed latent code is storable losslessly at a bit rate based on the probability model. The processor may further receive a complex holographic video; and for each frame of the complex holographic video, encode a frame to obtain a standard compressed frame, and encode a residual to a latent code, where the standard compressed frame and the residual to the latent code are transmitted together for each frame. The standard compressed frame may be according to High Efficiency Video Coding “HEVC” standard (H.265). Each frame of the complex holographic video may be received as a 12-channel tensor input. The system may be trained as a conditional generative adversarial network (GAN) with an encoder and a generator acting as a rival to a discriminator.

According to some examples, a system for image or video decompression may include a processor and a memory storing instructions. When executed by the processor, the instructions may cause the processor to receive a compressed image, where the compressed image is obtained through compression of a quantized latent code for a complex hologram image using an entropy coding technique; decode the compressed image; and classify the decoded image to obtain an uncompressed image.

According to some examples, the compressed image may be decoded to obtain a lossy reconstruction based on the complex hologram image. The processor may further generate a scalar value at a discriminator indicating a probability of a lossless reconstruction of the complex hologram image being real and another scalar value indicating a probability of the lossy reconstruction of the complex hologram image being real. The processor may also receive a compressed complex holographic video that comprises a standard compressed frame and a residual to a latent code for each frame; and for each frame of the compressed complex holographic video, decode the standard compressed frame to obtain an uncompressed standard frame and the latent code to obtain a reconstructed residual; and combine the uncompressed standard frame and the reconstructed residual to obtain an uncompressed frame of the complex holographic video. The processor may train a generator and a discriminator to predict the residual for each frame by concatenating the residual and the standard compressed frame along a channel dimension. A prediction of the residual may include recovery of one or more motion vectors for compensation of a loss of interference fringes.

According to some examples, an image or video compression method may include receiving one of a complex hologram image and a complex hologram video at a processor; for the complex hologram image encoding a latent code for a real component and an imaginary component of the complex hologram image; quantizing the latent code; and compressing the quantized latent code using an entropy coding technique to obtain a compressed image. The method may also include, for each frame of the complex hologram video, encoding a frame to obtain a standard compressed frame and encoding a residual to a latent code, wherein the standard compressed frame and the residual to the latent code are transmitted together for each frame.

According to some examples, receiving the complex hologram image may include receiving the complex hologram image as a 6-channel tensor input; and receiving the complex hologram video may include receiving each frame of the complex hologram video as a 12-channel tensor input with the standard compressed frame being according to High Efficiency Video Coding “HEVC” standard (H.265). Compressing the quantized latent code using the entropy coding technique may include using a probability model and arithmetic coding for the entropy coding technique such that the compressed latent code is storable losslessly at a bit rate based on the probability model.

According to some examples, the method may further include, for the complex hologram image, receiving a compressed image, where the compressed image is obtained through compression of a quantized latent code for the complex hologram image using an entropy coding technique; decoding the compressed image; and classifying the decoded image to obtain an uncompressed image; and, for the complex holographic video, receiving a compressed complex holographic video that comprises a standard compressed frame and a residual to a latent code for each frame; decoding the standard compressed frame to obtain an uncompressed standard frame and the latent code to obtain a reconstructed residual; and combining the uncompressed standard frame and the reconstructed residual to obtain an uncompressed frame of the complex holographic video.

According to some examples, the method may further include decoding the compressed image to obtain a lossy reconstruction based on the complex hologram image; and generating a scalar value indicating a probability of a lossless reconstruction of the complex hologram image being real and another scalar value indicating a probability of the lossy reconstruction of the complex hologram image being real. The method may also include training a generator and a discriminator to predict the residual for each frame by concatenating the residual and the standard compressed frame along a channel dimension, where a prediction of the residual may include recovery of one or more motion vectors for compensation of a loss of interference fringes.

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A system for image or video compression comprising:
a processor; and
a memory storing instructions, which when executed by the processor, cause the processor to:
receive a complex hologram image;
encode a latent code for a real component and an imaginary component of the complex hologram image;
quantize the latent code; and
compress the quantized latent code using an entropy coding technique to obtain a compressed image.

2. The system of claim 1, wherein the complex hologram image is received as a 6-channel tensor input.

3. The system of claim 1, wherein the quantized latent code is compressed using a probability model.

4. The system of claim 3, wherein the entropy coding technique employs arithmetic coding such that the compressed latent code is storable losslessly at a bit rate based on the probability model.

5. The system of claim 1, wherein the processor is further to:
receive a complex holographic video; and
for each frame of the complex holographic video,
encode a frame to obtain a standard compressed frame, and
encode a residual to a latent code, wherein the standard compressed frame and the residual to the latent code are transmitted together for each frame.

6. The system of claim 5, wherein the standard compressed frame is according to High Efficiency Video Coding “HEVC” standard (H.265).

7. The system of claim 5, wherein each frame of the complex holographic video is received as a 12-channel tensor input.

8. The system of claim 1, wherein the system is trained as a conditional generative adversarial network (GAN) with an encoder and a generator acting as a rival to a discriminator.

9. A system for image or video decompression comprising:
a processor; and
a memory storing instructions, which when executed by the processor, cause the processor to:
receive a compressed image, wherein the compressed image is obtained through compression of a quantized latent code for a complex hologram image using an entropy coding technique;
decode the compressed image; and
classify the decoded image to obtain an uncompressed image.

10. The system of claim 9, wherein the compressed image is decoded to obtain a lossy reconstruction based on the complex hologram image.

11. The system of claim 10, wherein the processor is further to generate a scalar value at a discriminator indicating a probability of a lossless reconstruction of the complex hologram image being real and another scalar value indicating a probability of the lossy reconstruction of the complex hologram image being real.

12. The system of claim 9, wherein the processor is further to:
receive a compressed complex holographic video that comprises a standard compressed frame and a residual to a latent code for each frame; and
for each frame of the compressed complex holographic video,
decode the standard compressed frame to obtain an uncompressed standard frame and the latent code to obtain a reconstructed residual; and
combine the uncompressed standard frame and the reconstructed residual to obtain an uncompressed frame of the complex holographic video.

13. The system of claim 12, wherein the processor is to train a generator and a discriminator to predict the residual for each frame by concatenating the residual and the standard compressed frame along a channel dimension.

14. The system of claim 13, wherein a prediction of the residual comprises recovery of one or more motion vectors for compensation of a loss of interference fringes.

15. An image or video compression method comprising:
receiving one of a complex hologram image and a complex hologram video at a processor;
for the complex hologram image:
encoding a latent code for a real component and an imaginary component of the complex hologram image;
quantizing the latent code; and
compressing the quantized latent code using an entropy coding technique to obtain a compressed image; and
for each frame of the complex hologram video:
encoding a frame to obtain a standard compressed frame; and
encoding a residual to a latent code, wherein the standard compressed frame and the residual to the latent code are transmitted together for each frame.

16. The method of claim 15, wherein
receiving the complex hologram image comprises receiving the complex hologram image as a 6-channel tensor input; and
receiving the complex hologram video comprises receiving each frame of the complex hologram video as a 12-channel tensor input with the standard compressed frame being according to High Efficiency Video Coding “HEVC” standard (H.265).

17. The method of claim 15, wherein compressing the quantized latent code using the entropy coding technique comprises:
using a probability model and arithmetic coding for the entropy coding technique such that the compressed latent code is storable losslessly at a bit rate based on the probability model.

18. The method of claim 15, further comprising:
for the complex hologram image:
receiving a compressed image, wherein the compressed image is obtained through compression of a quantized latent code for the complex hologram image using an entropy coding technique;
decoding the compressed image; and
classifying the decoded image to obtain an uncompressed image; and
for the complex holographic video:
receiving a compressed complex holographic video that comprises a standard compressed frame and a residual to a latent code for each frame;
decoding the standard compressed frame to obtain an uncompressed standard frame and the latent code to obtain a reconstructed residual; and
combining the uncompressed standard frame and the reconstructed residual to obtain an uncompressed frame of the complex holographic video.

19. The method of claim 18, further comprising:
decoding the compressed image to obtain a lossy reconstruction based on the complex hologram image; and
generating a scalar value indicating a probability of a lossless reconstruction of the complex hologram image being real and another scalar value indicating a probability of the lossy reconstruction of the complex hologram image being real.

20. The method of claim 18, further comprising:
training a generator and a discriminator to predict the residual for each frame by concatenating the residual and the standard compressed frame along a channel dimension, wherein a prediction of the residual comprises recovery of one or more motion vectors for compensation of a loss of interference fringes.
